(19) United States
(12) Patent Application Publication
(10) Pub. No.: US 2010/0316986 A1
(43) Pub. Date: Dec. 16, 2010

(54) RUBRIC-BASED ASSESSMENT WITH PERSONALIZED LEARNING RECOMMENDATIONS

(75) Inventors: Sebastian de la Chica, Redmond, WA (US); Eric A. Jenkins, JR., Kirkland, WA (US); Zubin Alexander, Bothel, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/483,251

(22) Filed: Jun. 12, 2009

(51) Int. Cl. G09B 7/00

(52) U.S. Cl. 434/362

(57) ABSTRACT

A rubric-based assessment and personalized learning recommendation system and method to aid an educator in teaching an entity in an efficient manner. Embodiments of the system and method include a computational representation of a rubric that is composed of composable rubric constructs. Each composable rubric construct corresponds to a particular sub-area of a skill being learned. Embodiments of the system and method also allow the educator to select a level of granularity of the rubric. This allows grouping together of entities that are having similar problems learning the skill and are performing similarly in certain areas. Embodiments of the system and method can suggest available learning resources for a single or groups of entities struggling in the same or similar areas based on their assessment results. The idea is for the entity to use these learning resources to improve its performance and competency in a given subject area.

### BACKGROUND

Rubrics frequently are used to assess performance of an entity (such as a human being or a machine). In general, a rubric is a description of different levels of mastery of a particular task or subject area. In the area of human performance, rubrics can be applied to traditional subjects (such as mathematics, English, and composition) as well as trades such as woodworking or metalworking.

Rubrics are useful in assessing performance of an entity. By way of example, using an example from education, assume that an educator is grading an essay and wishes to assess a student's performance on the essay in the areas of grammar, spelling, and content development. Within each of those areas, the educator typically will define a rubric having different levels of expertise (such as beginner, intermediate, advanced) in each of these three areas. Using the rubric, the educator has a benchmark by which to grade a student's essay by assigning a sub-grade in each area. The educator then uses these sub-grades to arrive at an overall grade. Rubrics can also contain exemplars, which provide a standard of a particular level of mastery. For example, a rubric may contain an exemplar essay of what essays having an advanced level of content development look like.

Rubrics also are useful in standardizing the way in which different educators assess the performance of students. A common rubric throughout an English department of a school, for example, provides more consistent grading between educators than might otherwise exist if each educator was using their own grading scheme. The rubric also allows a school or department to provide meaningful comparisons as to how a student is performing under different educators. In addition, the rubric helps educators create effective educational material by targeting specific areas where the student is having difficulty. This avoids comparing asymmetric metrics and avoids decisions made based on inaccurate information that may not be useful or appropriate.

As noted in the example given above, assessing human performance related to knowledge, skills, attitudes and beliefs is often reduced to the generation of a single score based on performance on a variety of tasks. While such simplifications have become a common occurrence in many learning situations, a single score hide the richness and complexity of human learning processes. Moreover, such reduction to a single score effectively inhibits the deployment of productive educational interventions that would lead to significant learning improvements.

By the time a single score has been computed it is either impossible to tease out a student's pedagogical needs or too late for an effective pedagogical strategy to have any impact on performance. Rich computational representations of rubrics enable a sophisticated ecosystem of meaningful, personalized assessment and learning services, materials, and resources. In particular, rubrics capture the internal structure and pedagogical intent of assessment tools, tasks, and instruments. This makes the assessment Information more actionable from a learning perspective.

In education, one problem with giving a student a single overall grade is that this approach often masks the underlying difficulty a student may be having mastering the subject matter. It is difficult for both the educator and the student to know in which areas the student is lacking and needs improvement. This inhibits the ability of both the teacher and the student to target improvements in the specific areas in which the student is lacking.

Rubrics have existed for a long time in the form of paper rubrics, which are rubrics that are written manually on paper. However, one problem with rubrics on paper is that this technique does not scale very well. Moreover, this paper rubric technique requires a great deal of data entry and requires a lot of time examining and interpreting the data. In the field of education, an additional problem is that the motivated educator is relied upon to examine the data to identify areas in which a student may be having problems and then taking steps to correct these problems.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments of the rubric-based assessment and personalized learning recommendation system and method provide techniques to aid the educator in assisting a student to learn in an efficient manner. Similar to traditional learning, rubrics are used to help in assessing the student's mastery of a subject area or skill. However, embodiments of the rubric-based assessment and personalized learning recommendation system and method include a computational representation of a rubric. This computational representation of a rubric is a benchmark that enables a rich and fine-grained characterization of the learning goals of any kind of assessment, the grading scheme (including performance levels, criteria, and exemplars), and the performance of a student on an assessment or collection of assessments over time.

Embodiments of the rubric-based assessment and personalized learning recommendation system and method make use of a rubric that is composed of composable rubric constructs. Each composable rubric construct corresponds to a particular sub-area of the skill or topic. For example, if the subject is English, the corresponding English rubric may be composed of composable rubric constructs including one for grammar, one for spelling, and one for content development. The use of composable rubric constructs makes rubrics and their component parts highly reusable, thus enabling homogeneity of assessment and grading practices. In addition, the composability of the composable rubric constructs allows logical grouping of related elements of performance, tracking the evolution of performance over time, normalization of scores from different educational institutions and communities, alignment to formal and informal localized learning standards, and alignment to external learning ontologies.

The composable rubric constructs also allow rich longitudinal analytics and individualized automated learning interactions through rubrics-based personalized learning services. In addition, an educator can select the level of granularity desired of the rubric. For example, if an educator has a group of 20 students, the ideal situation is for the educator to have an individual pedagogical (or lesson) plan for each of the 20 students to enable each student to improve in their area of weakness. Realistically, however, the educator only has a limited amount of resources and time and to have an individual pedagogical plan for each student is unreasonable. Embodiments of the rubric-based assessment and personalized learning recommendation system and method allow the educator to select a level of granularity that the educator feels comfortable with and group the students accordingly. For example, if the educator can handle 5 groups of students, then embodiments of the rubric-based assessment and personalized learning recommendation system and method group the students into 5 groups based on the particular learning problems they are having and provide the educator with personalized pedagogical plans, materials, and resources for each of the groups.

Rubrics are an integral part of embodiments of the rubric-based assessment and personalized learning recommendation system and method. The system and method allow pedagogical planning, where the educator can plan for a series of lectures on a topic, and embodiments of the rubric-based assessment and personalized learning recommendation system and method can describe a rubric that captures what is being taught in that series of lectures. In addition, embodiments of the rubric-based assessment and personalized learning recommendation system and method can map assessments to rubrics. For personalized learning resources, embodiments of the rubric-based assessment and personalized learning recommendation system and method can capture which portion of the available learning resources maps to or addresses a particular sub-area of a skill represented by a composable rubric construct.

Embodiments of the rubric-based assessment and personalized learning recommendation system and method provide technological support to help educators with assessing students by using automated processing. At its most basic level, embodiments of the rubric-based assessment and personalized learning recommendation system and method can be used as a data entry system. This allows an educator to store data the system in an electronic format. Embodiments of the rubric-based assessment and personalized learning recommendation system and method can then begin to generate rubrics and assessment results.

At a higher level, embodiments of the rubric-based assessment and personalized learning recommendation system and method can also be used to provide analytics regarding a student. These analytics include grouping students together that are having similar problems learning the skill and are performing similarly in certain areas. This alleviates the educator from having to process large amounts of data and from having to identify meaningful patterns in the data.

The next level up is where the educator relies even more on embodiments of the rubric-based assessment and personalized learning recommendation system and method by allowing the system and method to suggest a personalized pedagogical plan to correct any learning deficiencies. Embodiments of the rubric-based assessment and personalized learning recommendation system and method can suggest available learning resources for a single or groups of students struggling in the same or similar areas based on their assessment results. These learning resources include text-based resource (such as reading a book), an interactive resource (such as exercises than require input), or richer multi-media interactions. The goal is for the student to use these learning resources to improve their performance and competency in a given subject area.

It should be noted that alternative embodiments are possible, and that steps and elements discussed herein may be changed, added, or eliminated, depending on the particular embodiment. These alternative embodiments include alternative steps and alternative elements that may be used, and structural changes that may be made, without departing from the scope of the invention.

### DRAWINGS DESCRIPTION

Referring now to the drawings in which like reference numbers represent corresponding parts throughout:

FIG. 1 is a block diagram illustrating a general overview of a rubric-based assessment and personalized learning recommendation system implemented on a computing device.

FIG. 2 is a flow diagram illustrating the general operation of embodiments of the rubric-based assessment and personalized learning recommendation system and method shown in FIG. 1.

FIG. 3 is a block diagram illustrating details of the rubric generation module shown in FIG. 1.

FIG. 4 is a flow diagram illustrating the detailed operation of embodiments of the rubric generation module shown in FIGS. 1 and 3.

FIG. 5 is a block diagram illustrating details of the rubric services module shown in FIG. 1.

FIG. 6 is a flow diagram illustrating the detailed operation of embodiments of the analytics services module shown in FIG. 5.

FIG. 7 is a block diagram illustrating details of the recommender and personalization services module shown in FIG. 5.

FIG. 8 is a flow diagram illustrating the detailed operation of embodiments of the recommender and personalization services module shown in FIGS. 5 and 7.

FIG. 9 illustrates an example of a suitable computing system environment in which embodiments of the rubric-based assessment and personalized learning recommendation system and method shown in FIGS. 1-8 may be implemented.

### DETAILED DESCRIPTION

In the following description of embodiments of the rubric-based assessment and personalized learning recommendation system and method reference is made to the accompanying drawings, which form a part thereof, and in which is shown by way of illustration a specific example whereby embodiments of the rubric-based assessment and personalized learning recommendation system and method may be practiced. It is to be understood that other embodiments may be utilized and structural changes may be made without departing from the scope of the claimed subject matter.

### I. System Overview

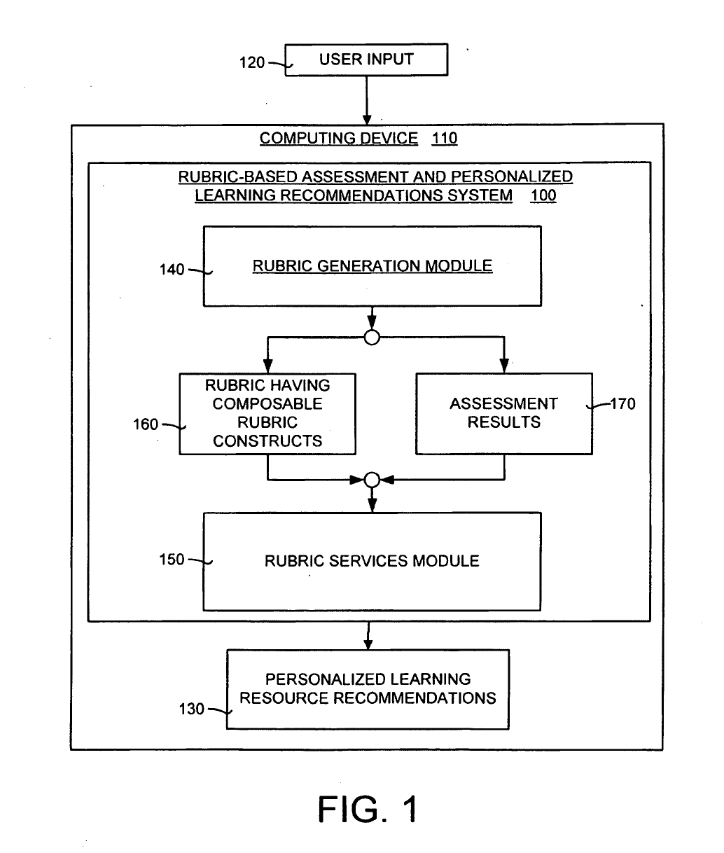

FIG. 1 is a block diagram illustrating a general overview of a rubric-based assessment and personalized learning recommendation system 100 implemented on a computing device 110. In particular, the rubric-based assessment and personalized learning recommendation system 100 shown in FIG. 1 receives user input 120 (typically from an educator or other learning professional) and outputs personalized learning resource recommendations 130 for a particular entity. As used in this document, the term “entity” can be a human, animal, or a machine. Moreover, the term also includes a single human, animal, or machine, or several humans, animal, or machines assigned together in a group based on similar learning needs. For example, an entity can be a single student, a group of students having trouble in similar subject areas, or a machine learning a task.

The rubric-based assessment and personalized learning recommendation system 100 includes a rubric generation module 140 and a rubric services module 150. In general, the rubric generation module 140 input a skill to be learned and outputs a rubric having composable rubric constructs 160 and assessment results 170. The rubric service module 150 uses the composable rubric constructs 160 and assessment results 170 to generate the personalized learning resource recommendations 130. Each of these modules is discussed in further detail below.

### II. Operational Overview

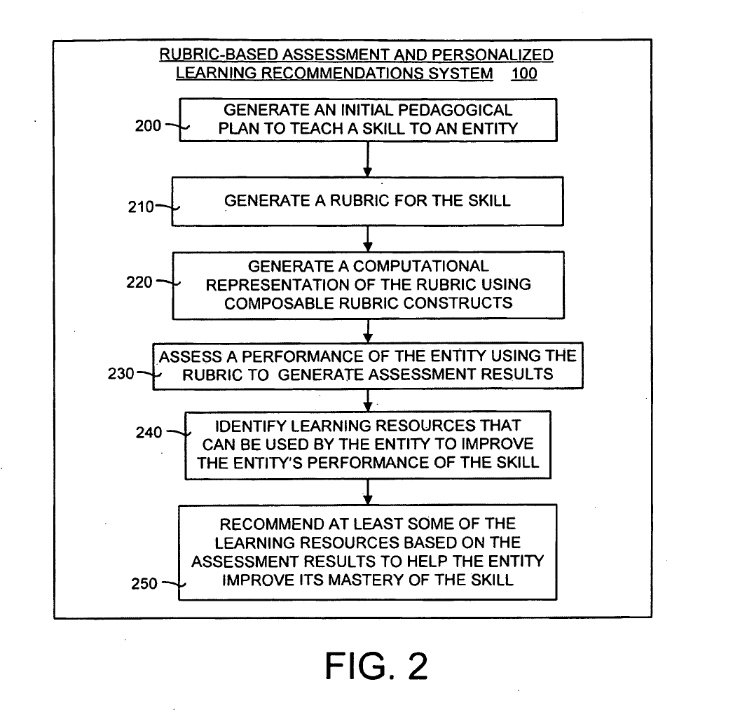

FIG. 2 is a flow diagram illustrating the general operation of embodiments of the rubric-based assessment and personalized learning recommendation system 100 and method shown in FIG. 1. Referring to FIG. 2, the method begins by generating an initial pedagogical plan to teach a skill to an entity (box 200). It should be noted that the term “skill” includes a variety of tasks or subject area that can be learned. In addition, the method generates a rubric for the skill (box 210). This rubric is used to measure or assess how well the entity has learned the skill.

Next, the method generates a computational representation of the rubric (box 220). This computation representation of the rubric is a benchmark that uses a plurality of composable rubric constructs. Composable rubric constructs means that the rubric constructs are composable. Composable is the idea that any number of rubrics constructs can be grouped together to form a larger another rubric construct. This allows various kinds of interesting scenarios to be supported automatically.

For example, in K-12 education, educators often need to worry about how what they teach in the classroom maps to state educational standards. There may be a gap between how the state standards discuss grammar and what the educator is doing in the classroom. Or, there may be a gap between how the educator teaches essays and how the state standards view essays. So maybe the educator is measuring spelling, grammar, and content development in the essays and wants to be able to roll up the scores so that the spelling and the grammar are a single grade. Composable rubric constructs allow the educator to compose the spelling and grammar rubric constructs into a single rubric construct.

Composable rubric constructs also allow ever finer-grained decomposition of a group of entities (such as a group of students) so that an educator can do a more detailed analysis. For example, suppose an educator wants to break grammar into subsets such as subject noun, matching, use of prepositional phrases, and so forth, so that a finer analysis of the skills being assessed can be made. In this case, the rubric can be composed of as many composable rubric constructs as the educator desires in order to capture the desired level of detail.

The system 100 then assesses a performance of the entity using the rubric (box 230). This assessment then is used to generate assessment results, which area scores or ratings of how well the entity performed in the assessment. There are many different ways to assess performance, and the general idea is to assess how well the entity has learned or mastered the skill. For example, a multiple-choice test or an essay is often used by an educator to assess a performance of a student as to how well that student has learned a particular subject area.

Once the assessment results have been generated, the system 100 then identifies learning resources that can be used by the entity to improve the entity's performance of the skill (box 240). These learning resources include text-based resource (such as reading a book), an interactive resource (such as exercises than require input), or richer multi-media interactions. The system 100 then recommends at least some of the learning resources based on the assessment results to help the entity improve its mastery of the skill (box 250). The goal is for the entity to use these recommended learning resources to improve its performance and competency in a given skill. Moreover, the system 100 can recommend learning resources for an entity containing a single member or an entity having a plurality of members. These members are grouped because the system 100 has determined that they are struggling in the same or similar areas of learning the skill based on their assessment results.

### III. System and Operational Details

The system and the operational details of embodiments of the rubric-based assessment and personalized learning recommendation system 100 and method now will be discussed. These embodiments include embodiments of the rubric generation module 140, the rubric service module 150, the analytics services module 500, and the recommender and personalization services module 530. The system and operational details of each of these programs modules now will be discussed in detail.

### III.A. Rubric Generation Module

Embodiments of the rubric-based assessment and personalized learning recommendation system 100 and method model assessment rubrics using the rubric generation module 140. The rubric generation module 140 is a set of distributed computation services to support the creation, editing, management and storage of rubrics. Rubric support extends to the scoring of assignments along one or more dimensions, as specified by the relevant rubric definitions. By providing support for rubrics, embodiments of the system 100 and method are able to support a wide range of educational applications targeting the practical application of rubrics in day-to-day educational activities for educators, learners and institutions. The rubric generation module 140 also includes assessment services, which are distributed computational services to evaluate an assessment artifact being created by an educator to assess coverage of a particular rubric or set of rubrics of interest.

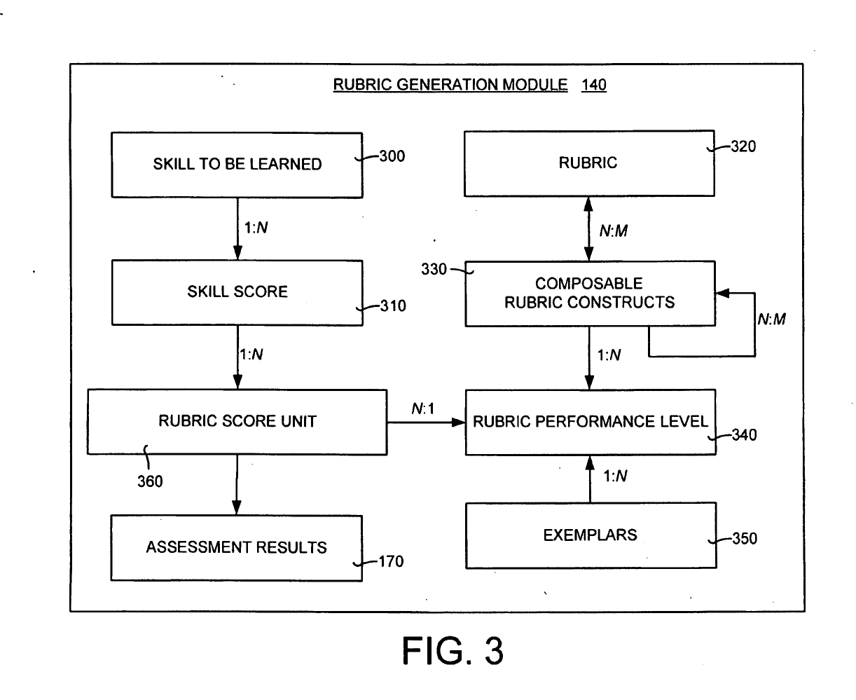

FIG. 3 is a block diagram illustrating details of the rubric generation module 140 shown in FIG. 1. As shown in FIG. 3, the rubric generation module 140 includes a skill 300 to be learned by an entity. This skill can be completing a task, such as taking a test or running 100 meters. Completion of this skill yields a skill score 310, which in general correspond to the entity's grade.

The rubric generation module 140 also includes a rubric 320. The rubric 320 serves as a container for grouping a description of the dimensions (such as knowledge, skills, attitudes, and/or beliefs) being measured using the rubric. The rubric 320 is composed of a plurality of composable rubric constructs 330 that correspond to the cognitive or non-cognitive dimensions being evaluated using the rubric 320. By way of example, composable rubric constructs may include a variety of sub-areas of a particular skill. For example, assume that the rubric is for English and the composable rubric constructs include such sub-areas as grammar, spelling, and content development.

The rubric generation module 140 also includes rubric performance levels 340. These are multiple performance levels associated with each of the composable rubric constructs. For example, each composable rubric construct may have three rubric performance levels of beginner, intermediate, and advanced. The rubric performance levels model each of the pedagogically useful degrees of mastery associated with the composable rubric constructs. For instance, a grammar composable rubric construct for an elementary school student in grade 5 might include three rubric performance levels designated as beginner, intermediate and advanced.

For each rubric performance level 340 there may be any number of exemplars 350 that may be associated with a rubric performance level 340. For example, an exemplar may be an example what a 12^{th} grade intermediate grammar essay looks like. The English subject example is very linear, in the fact that is just involves text. However, for other subjects, such as mathematics, the lines of reasoning may be more complex.

Embodiments of the rubric generation module 140 support a high degree of flexibility and reusability around composable rubric constructs 330. A rubric 320 may be composed of one or more composable rubric constructs 330 which may themselves be part of one or more composable rubric constructs 330. The practical implication is that once a composable rubric construct 330 for measuring some aspect of the learning process (such as grammar and spelling for high school grades 9-12) has been defined, that definition can be leveraged in multiple situations and by different rubrics 320 as an assessment tool. By including the same composable rubric construct 330 in multiple rubrics 320, different learning activities may be assessed using the same assessment criteria.

In addition, the composable rubric constructs 330 are highly composable within themselves. This self-referential relationship indicates that a composable rubric construct 330 may contain one or more composable rubric constructs 330 and that it may participate or be contained by multiple other composable rubric constructs 330. It should be noted that the implication is that composable rubric constructs 330 may be composed as a graph (not just a hierarchical tree), where any composable rubric construct 330 may have multiple child composable rubric constructs 330 and any child composable rubric construct 330 may have multiple parent composable rubric constructs 330.

The assessment results 170 associated with the rubric 320 are modeled using a rubric score unit 360. The rubric score unit 360 provides storage for the skill score 310 obtained by assessing a student's performance on some skill 300, such as writing an essay, along a particular composable rubric construct 330, such as grammar. In essence, the rubric score unit 360 is the glue mapping the skill 300 to the rubric 320 and all that can be done with the rubric 320 and its constituent composable rubric constructs 330. The rubric scoring unit 360 yields the assessment results 170, which measures how well the entity performed based on each on of the composable rubric constructs 330.

The ratios (such as 1:N) between the blocks in FIG. 3 are an attempt to capture the relationship between the two elements. This is a standard computer science notation such that 1:N means that when there is one activity then there can be N activity scores associated with that activity. In particular, the notation 1:N notation between the skill to be learned 300 and the skill score 310 means that for each skill to be learned 300 there can be N associated skill scores 310. Similarly, the 1:N notation between the skill score 310 and the rubric score unit 360 means that for each skill score 310 there can be N number of assessment results 170.

The N:M notation between the rubric 320 and the composable rubric constructs 330 mean that N number of rubrics can have M composable rubric constructs 330, such that one rubric 320 can have multiple composable rubric constructs 330, and the same composable rubric construct 330 can belong to multiple rubrics 320. In addition, the N:M notation adjacent the composable rubric constructs 330 (with the arrow looping back on the box) indicates that a single composable rubric construct 330 can have multiple composable rubric constructs 330 that are underneath it. Moreover, each of the multiple composable rubric constructs 330 underneath it can also reference multiple composable rubrics constructs 330 above them. In other words, the composable rubric constructs 330 can be nested.

The 1:N notation between the composable rubric constructs 330 and the rubric performance levels 340 indicates that for each composable rubric construct there can be N number of rubric performance levels 340. The 1:N notation between the rubric performance levels 340 and the exemplars 350 means that for each rubric performance level 340 there can be N number of exemplars 350. Moreover, the N:1 notation between the rubric score unit 360 and the rubric performance levels 340 means that the rubric score unit 360 can produce multiple assessment results 170 for each rubric performance level 340.

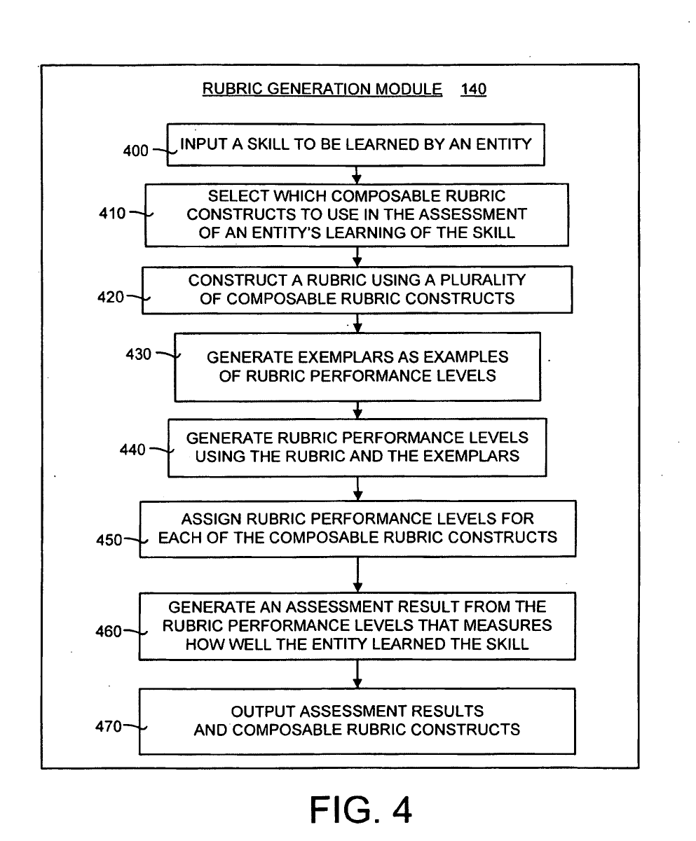

FIG. 4 is a flow diagram illustrating the detailed operation of embodiments of the rubric generation module 140 shown in FIGS. 1 and 3. The method begins by inputting a skill to be learned by an entity (box 400). Next, composable rubric constructs are selected to be used in the assessment of the entity's learning of the skill (box 410). The module 140 then constructs a rubric using a plurality of the composable rubric constructs (box 420).

The module 140 generates exemplars as examples of rubric performance levels (box 430). The exemplars then are used to generate the rubric performance levels along with the rubric (box 440). The module 140 then assigns rubric performance levels for each of the composable rubric constructs (box 450). Assessment results then are generated by the module 140 from the rubric performance levels (box 460). The assessment results measure how well the entity (such as a student) learned the skill. Finally, the module outputs the assessment results and the composable rubric constructs (box 470).

### III.B. Rubric Services Module

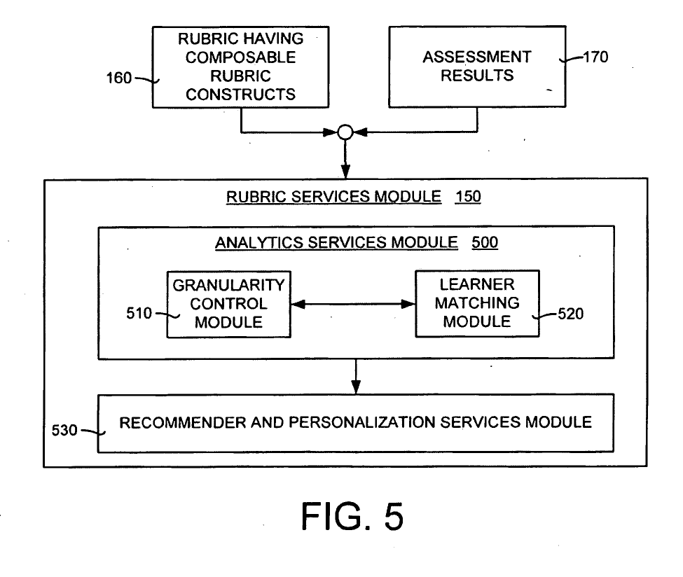

Embodiments of the rubric-based assessment and personalized learning recommendation system 100 and method include a rubric services module 150. The rubric services module 150 inputs the rubric having composable rubric constructs 160 and the assessment results 170. FIG. 5 is a block diagram illustrating details of the rubric services module 150 shown in FIG. 1. The rubric services module 150 also includes an analytics services module 500. The analytics services module 500 includes distributed computational services to analyze both identifiable and anonymous learner populations based on performance. This performance is assessed against the rubrics to identify patterns such as correlation between different aspects of different rubrics or to evaluate learner performance over time.

The analytics services module 500 provides an intermediate step between not knowing anything about the data collected in the form of the assessment results 170 and having an automatic service that is doing personalized learning recommendations. In classrooms situations, this is referred to as “differentiated learning.” Embodiments of the analytics services module 500 along with the composable rubric constructs 160 facilitate an educator refined pedagogical plans. An educator in the classroom does not have time to come up with a one-on-one individualized pedagogical (or learning) plan for each day of a learning period (such as a semester). The typical thing for an educator to do is to try and group students in their class according to similar needs.

The analytics services module 500 automatically groups together students having similar needs. In addition, this grouping aids in the refinement of an initial pedagogical plan, such that there is a refined pedagogical plan for each group of students having similar needs. The analytics services module 500 can also perform this matching at different levels of granularity. In particular, a granularity control module 510 allows the selection of a desired level of granularity. This feature supports the differentiated learning. For example, an educator can dial in the level of granularity that the educator feels he is able to manage.

Suppose that the educator has 20 students. The educator will probably not be able to handle an individualized pedagogical plan for each of those 20 students, but may be able to handle five groups. In this case, the educator would select a granularity that groups the 20 students into five groups based on the learning needs of the students (as set forth in the assessment results 170). This makes the educators job more manageable. The analytics service module 500 also includes a learner matching module 520 that generates groups of entities under the constraints of the granularity control module 510.

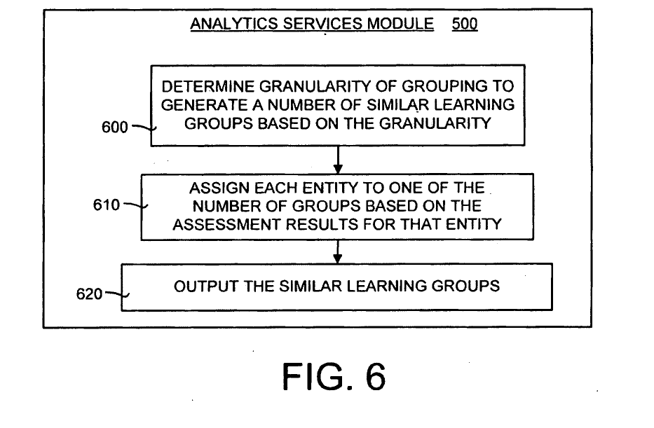

FIG. 6 is a flow diagram illustrating the detailed operation of embodiments of the analytics services module 500 shown in FIG. 5. The method begins by determining a granularity of grouping to generate a number of similar learning groups (box 600). The number of these groups is based on and constrained by the selected granularity. For example, in a coarser granularity is selected, then the number of similar learning groups will be less than if a finer granularity is selected. As a general rule, the finer the granularity that is selected, the more groups there will be and the more specific the assessment results will be in each of the groups.

The module 500 then assigns each entity to at least one of the number of similar learning groups (box 610). These assignments to a particular group are based on the assessment results 170. The general idea is to group entities that are having trouble with the same aspect of the skill to be learned. The module 500 then output the similar learning groups (box 620).

Embodiments of the rubric services module 150 also includes a recommender and personalization services module 530. This module 530 contains distributed computational services to recommend developmentally appropriate learning resources to entities (or learners) and educators based on the entities performance on one or more assessment instruments evaluated against one or more rubrics. This information is contained in the assessment results.

### III.C Recommender and Personalization Services Module

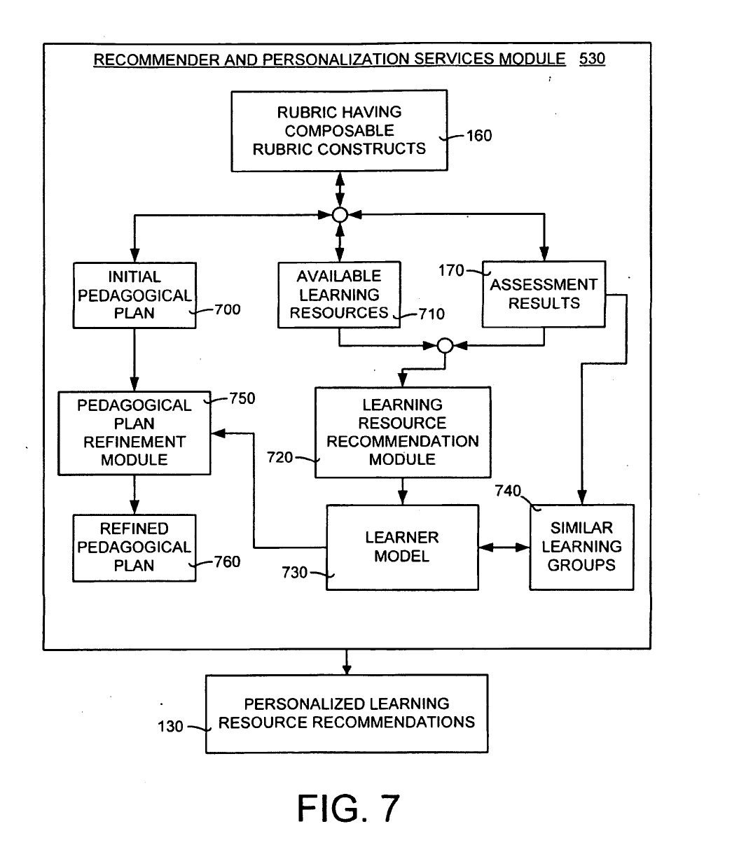

In general, the recommender and personalization services module 530 provides an entity (and the educator) with personalized pedagogical interactions modeled after human one-on-one tutoring situations. FIG. 7 is a block diagram illustrating details of the recommender and personalization services module 530 shown in FIG. 5. The module 530 leverages the rubrics having composable rubric constructs 160 to integrate information from the following sources: (a) an initial pedagogical plan 700 created by the educator; (b) assessment results170; and, (c) available learning resources 710 either supplied by the educator or obtained from external sources.

A key artifact generated from this module 530 is a learning resource recommendation module 720, which leverages the academic analytics supported by the analytics services module 500 to construct a learner model 730 based on rubrics information. This learner model 730 can be enacted using a variety of computational models ranging from simple key-value pairs to more sophisticated models, such as OLAP cubes, Bayesian networks or ontologies. A key aspect of the learner model 730 is that it uses rubrics to create a computational model of entity performance on a wide variety of activities over a period of time. For instance, the learner model 730 can capture a student's performance on solving first degree equations (a composable rubric construct) throughout the student's high school journey.

Embodiments of the recommender and personalization services module 530 use information contained in the rubric 160 to align learning goals expressed in the initial pedagogical plan with specific parts or subparts of the assessment results 170 and with descriptive metadata about available learning resources 710. For example, embodiments of the module 530 can compute which questions on a given assessment evaluate learner performance against some learning goals and which learning resources support students in the attainments of those goals. Learner performance on each assessment instrument is also modeled using the information contained in the rubric 10, such that the module 530 can determine (or infer) which learning resources provide support for learners to attain certain learning goals.

Based on the information in the learner model, embodiments of the module 530 can also identify which learning goals are causing a particular entity to struggle, which assessment questions are being missed, and what additional learning resources may be helpful. Initially the module 530 uses the metadata in the learning resources used by the educator as part of the instructional process to identify other external learning resources with similar characteristics. In other words, these learning resources are aligned to the same or similar rubric 160 or collection of rubrics.

Once embodiments of the module 530 have collected enough data over time about a large entity population, the module 530 uses one or more computation techniques to suggest learning resources. In some embodiments of the module 530 a collaborative filtering approach is used. However, collaborative filtering techniques are one example of a computation technique that may be appropriate. In other embodiments of the module 530, and depending on the amount of data available to module 530, other types of computation techniques may be employed (such as machine learning techniques) to suggest learning resources. These learning resources are most likely to help a particular entity or group of entities improve their performance based on the experiences of learners with similar characteristics. In other words, the similar learning groups 740 are entities who have performed similarly on the same or similar rubric 160.

Embodiments of the recommender and personalization services module 530 also include a pedagogical plan refinement module 750. Based on the learner model 730, the initial pedagogical plan 700 is refined to specifically help each of the similar learning groups 740 use at least some of the available learning resources 710 to improve mastery of the skill to be learned. The output of the recommender and personalization services module 530 is the personalized learning resource recommendations 130. The learning resources can be personalized for a particular entity (such as a student) or for a particular group of entities (such as a group of students in a similar learning group).

The module 530 has taken has input the learning goals of the educator and the results of the assessment instruments, and has yielded the learning resources that are available to the entity to help it improve in learning the skill. In addition, it should be noted that the system 100 makes liberal use of the rubrics having composable rubric constructs. In fact, the pedagogical learning is captured in terms of rubrics, the assessment results 170 are captured rubrics, and the learning resources are captured in terms of rubrics.

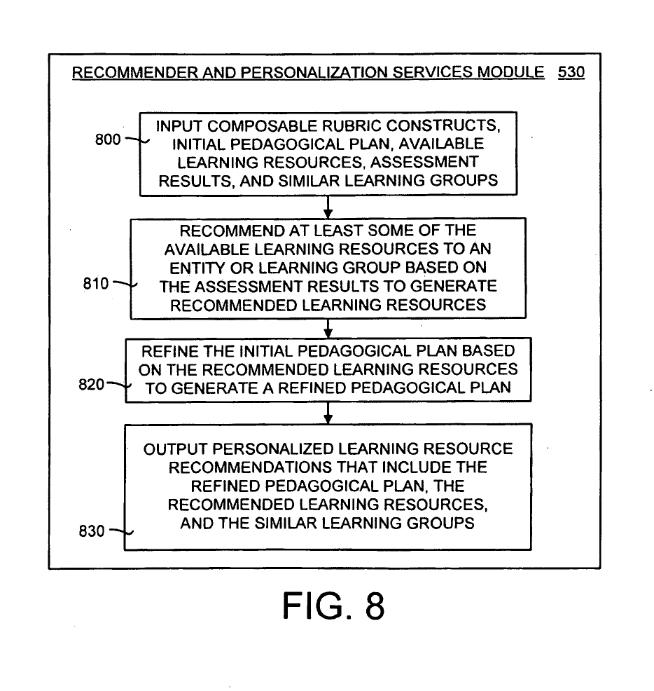

FIG. 8 is a flow diagram illustrating the detailed operation of embodiments of the recommender and personalization services module 530 shown in FIGS. 5 and 7. The method begins by inputting composable rubric constructs, an initial pedagogical plan, available learning resources, assessment results, and similar learning groups (box 800). Next, the module 530 recommends at least some of the available learning resources to an entity or similar learning group based on the assessment results (box 810). This generates recommended learning resources.

The module 530 then refines the initial pedagogical plan based on the recommended learning resources to generate a refined pedagogical plan (box 820). The output of the module 530 is a personalized learning resource recommendation (box 830). This recommendation includes the refined pedagogical plan, the recommended learning resources, and the similar learning groups.

### IV. Exemplary Operating Environment

Embodiments of the rubric-based assessment and personalized learning recommendation system 100 and method are designed to operate in a computing environment. The following discussion is intended to provide a brief, general description of a suitable computing environment in which embodiments of the rubric-based assessment and personalized learning recommendation system 100 and method may be implemented.

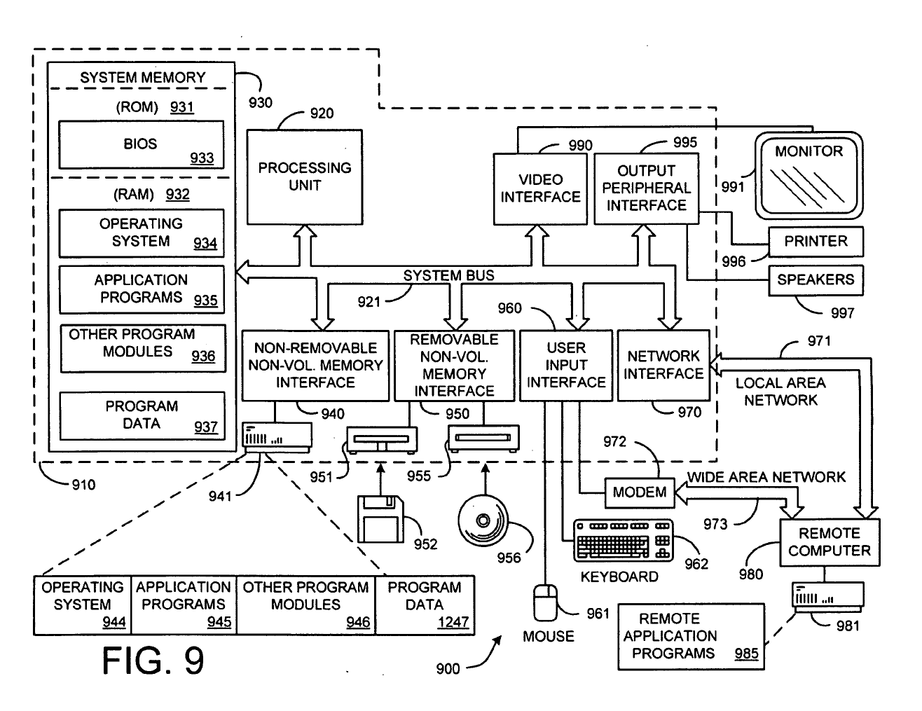

FIG. 9 illustrates an example of a suitable computing system environment in which embodiments of the rubric-based assessment and personalized learning recommendation system 100 and method shown in FIGS. 1-8 may be implemented. The computing system environment 900 is only one example of a suitable computing environment and is not intended to suggest any limitation as to the scope of use or functionality of the invention. Neither should the computing environment 900 be interpreted as having any dependency or requirement relating to any one or combination of components illustrated in the exemplary operating environment.

Embodiments of the rubric-based assessment and personalized learning recommendation system 100 and method are operational with numerous other general purpose or special purpose computing system environments or configurations. Examples of well known computing systems, environments, and/or configurations that may be suitable for use with embodiments of the rubric-based assessment and personalized learning recommendation system 100 and method include, but are not limited to, personal computers, server computers, hand-held (including smartphones), laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

Embodiments of the rubric-based assessment and personalized learning recommendation system 100 and method may be described in the general context of computer-executable instructions, such as program modules, being executed by a computer. Generally, program modules include routines, programs, objects, components, data structures, etc., that perform particular tasks or implement particular abstract data types. Embodiments of the rubric-based assessment and personalized learning recommendation system 100 and method may also be practiced in distributed computing environments where tasks are performed by remote processing devices that are linked through a communications network. In a distributed computing environment, program modules may be located in both local and remote computer storage media including memory storage devices. With reference to FIG. 9, an exemplary system for embodiments of the rubric-based assessment and personalized learning recommendation system 100 and method includes a general-purpose computing device in the form of a computer 910.

Components of the computer 910 may include, but are not limited to, a processing unit 920 (such as a central processing unit, CPU), a system memory 930, and a system bus 921 that couples various system components including the system memory to the processing unit 920. The system bus 921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 910 typically includes a variety of computer readable media. Computer readable media can be any available media that can be accessed by the computer 910 and includes both volatile and nonvolatile media, removable and non-removable media. By way of example, and not limitation, computer readable media may comprise computer storage media and communication media. Computer storage media includes volatile and nonvolatile removable and non-removable media implemented in any method or technology for storage of information such as computer readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 910. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 930 includes computer storage media in the form of volatile and/or nonvolatile memory such as read only memory (ROM) 931 and random access memory (RAM) 932. A basic input/output system 933 (BIOS), containing the basic routines that help to transfer information between elements within the computer 910, such as during start-up, is typically stored in ROM 931. RAM 932 typically contains data and/or program modules that are immediately accessible to and/or presently being operated on by processing unit 920. By way of example, and not limitation, FIG. 9 illustrates operating system 934, application programs 935, other program modules 936, and program data 937.

The computer 910 may also include other removable/non-removable, volatile/nonvolatile computer storage media. By way of example only, FIG. 9 illustrates a hard disk drive 941 that reads from or writes to non-removable, nonvolatile magnetic media, a magnetic disk drive 951 that reads from or writes to a removable, nonvolatile magnetic disk 952, and an optical disk drive 955 that reads from or writes to a removable, nonvolatile optical disk 956 such as a CD ROM or other optical media.

Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 941 is typically connected to the system bus 921 through a non-removable memory interface such as interface 940, and magnetic disk drive 951 and optical disk drive 955 are typically connected to the system bus 921 by a removable memory interface, such as interface 950.

The drives and their associated computer storage media discussed above and illustrated in FIG. 9, provide storage of computer readable instructions, data structures, program modules and other data for the computer 910. In FIG. 9, for example, hard disk drive 941 is illustrated as storing operating system 944, application programs 945, other program modules 946, and program data 947. Note that these components can either be the same as or different from operating system 934, application programs 935, other program modules 936, and program data 937. Operating system 944, application programs 945, other program modules 946, and program data 947 are given different numbers here to illustrate that, at a minimum, they are different copies. A user may enter commands and information (or data) into the computer 910 through input devices such as a keyboard 962, pointing device 961, commonly referred to as a mouse, trackball or touch pad, and a touch panel or touch screen (not shown).

Other input devices (not shown) may include a microphone, joystick, game pad, satellite dish, scanner, radio receiver, or a television or broadcast video receiver, or the like. These and other input devices are often connected to the processing unit 920 through a user input interface 960 that is coupled to the system bus 921, but may be connected by other interface and bus structures, such as, for example, a parallel port, game port or a universal serial bus (USB). A monitor 991 or other type of display device is also connected to the system bus 921 via an interface, such as a video interface 990. In addition to the monitor, computers may also include other peripheral output devices such as speakers 997 and printer 996, which may be connected through an output peripheral interface 995.

The computer 910 may operate in a networked environment using logical connections to one or more remote computers, such as a remote computer 980. The remote computer 980 may be a personal computer, a server, a router, a network PC, a peer device or other common network node, and typically includes many or all of the elements described above relative to the computer 910, although only a memory storage device 981 has been illustrated in FIG. 9. The logical connections depicted in FIG. 9 include a local area network (LAN) 971 and a wide area network (WAN) 973, but may also include other networks. Such networking environments are commonplace in offices, enterprise-wide computer networks, intranets and the Internet.

When used in a LAN networking environment, the computer 910 is connected to the LAN 971 through a network interface or adapter 970. When used in a WAN networking environment, the computer 910 typically includes a modem 972 or other means for establishing communications over the WAN 973, such as the Internet. The modem 972, which may be internal or external, may be connected to the system bus 921 via the user input interface 960, or other appropriate mechanism. In a networked environment, program modules depicted relative to the computer 910, or portions thereof, may be stored in the remote memory storage device. By way of example, and not limitation, FIG. 9 illustrates remote application programs 985 as residing on memory device 981. It will be appreciated that the network connections shown are exemplary and other means of establishing a communications link between the computers may be used.

The foregoing Detailed Description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A method implemented on a computing device having a processor for creating a personalized pedagogical plan for an entity, comprising:
using the computing device having the processor to perform the following:
generating an initial pedagogical plan to teach the entity a desired skill;
generating a computational representation of a rubric for the skill that provides a benchmark to which a performance of the skill by the entity can be compared;
assessing the performance using the rubric to generate assessment results;
identifying available learning resources that can be used improve the entity's performance of the skill; and
recommending at least some of the learning resources based on the assessment results to allow the entity to improve its mastery of the skill.

2. The method of claim 1, further comprising:
selecting composable rubric constructs to use in the assessment of the learning of the skill; and
constructing the rubric using a plurality of the selected composable rubric constructs to generate the computational representation of the rubric.

3. The method of claim 2, further comprising associating multiple rubric performance levels with each of the composable rubric constructs.

4. The method of claim 3, further comprising generating multiple exemplars for each of the rubric performance levels as examples of a performance at a certain rubric performance level.

5. The method of claim 4, further comprising generating the rubric performance levels using the rubric and the exemplars.

6. The method of claim 1, further comprising selecting a granularity of grouping to generate a number of similar learning groups in which entities having similar deficiencies in learning the skill are placed, such that a coarser granularity provides a lesser number of similar learning groups as compared to a finer granularity that provides a greater number of similar learning groups.

7. The method of claim 6, further comprising assigning each entity to one of the similar learning groups based on assessment results for that entity as measured by the rubric.

8. The method of claim 7, further comprising refining the initial pedagogical plan based on the recommended learning resources to generate a refined pedagogical plan.

9. The method of claim 8, further comprising generating a refined pedagogical plan for each of the similar learning groups.

10. A method implemented on a computing device having a processor for assessing performance of an entity in performing a particular skill, comprising:
using the computing device having the processor to perform the following:
generating a rubric for the skill that provided a benchmark of how the entity's performance in the skill will be assessed;
defining a composable rubric construct for each sub-area of the skill, where each sub-area corresponds to a discrete portion of the skill;
composing a rubric from each of the composable rubric constructs such that the rubric contains each of the composable rubric constructs; and
assessing the performance of the entity using the rubric to generate assessment results for the entity.

11. The method of claim 10, further comprising generating a plurality of rubric performance levels for each of the composable rubric constructs to aid in assessing the performance of the entity and indicate how well the entity learned the skill.

12. The method of claim 11, further comprising generating exemplars for each of the rubric performance levels to provides examples of a performance by an entity as a particular rubric performance level.

13. The method of claim 12, further comprising using the exemplars and the rubric to construct the rubric performance levels.

14. The method of claim 13, further comprising:
determining available learning resources; and
recommending at least some of the available learning resources to the entity based on the assessment results and the rubric performance levels to generate personalized learning resource recommendations for the entity.

15. The method of claim 14, further comprising:
assessing a performance of several different entities using the rubric to generate a plurality of assessment results for each of the entities in the skill; and
selecting a granularity of grouping to generate a number of similar learning groups, where each similar learning group contains entities that have similar assessment results.

16. The method of claim 15, further comprising assigning each of the entities to one of the similar learning groups based on the assessment results for a particular entity.

17. A computer-implemented method for helping a group of students learn a skill, comprising:
generating an initial pedagogical plan designed to help an educator teach the skill to the group of students;
defining a rubric for the skill by which each student's mastery of the skill can be determined;
generating a computational representation of the rubric using composable rubric constructs, where each composable rubric construct corresponds to a sub-area of the skill;
testing a knowledge of the skill of each of the students in the form of a test;
assessing each student's performance on the test using the rubric to generate assessment results;
identifying available learning resources that will help each student improve in the skill; and
providing personalized learning resource recommendations of at least some of the available learning resources to each of the students to help each student improve in an area of the skill in which the student is having trouble so as to improve in the skill.

18. The computer-implemented method of claim 17, further comprising:
allowing the educator to select a granularity of grouping desired by the educator to obtain a number of similar learning groups such that a coarser granularity provides fewer similar learning groups and a finer granularity provides more similar learning groups; and
grouping the group of students into the number of similar learning groups based on each student's performance on the test such that students having trouble in similar sub-areas of the skill are grouped together in similar learning groups.

19. The computer-implemented method of claim 18, further comprising providing personalized learning resource recommendations to each of the similar learning groups based on the assessment results of each student in a particular similar learning group.

20. The computer-implemented method of claim 19, further comprising refining the initial pedagogical plan to include a refined pedagogical plan for each of the similar learning groups based on the personalized learning resource recommendations for each of the similar learning groups.
